(19) United States
(12) Patent Application Publication
(10) Pub. No.: US 2008/0108773 A1
(43) Pub. Date: May 8, 2008

(54) Polyurethane dispersions containing POSS nanoparticles

(76) Inventors: Douglas A. Wicks, Hattiesburg, MS (US); Ajaya K. Nanda, Hattiesburg, MS (US); Joshua U. Otaigbe, Hattiesburg, MS (US); Samy A. Madbouly, Hattiesburg, MS (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/593,383

(22) Filed: Nov. 6, 2006

(51) Int. Cl. C08G 71/04; C08G 77/00

(52) U.S. Cl. 528/12; 528/44

(57) ABSTRACT

A process for forming a polyurethane dispersion containing polyhedral oligomeric silsesquioxane (POSS) nanoparticles, comprising reacting a POSS with a diisocyanate in the presence of acetone, reacting the resulting compound with a polyol and an ionic compound selected from the group consisting of an acidic diol or sodium sulfonate to form an isocyanate prepolymer chain, extending the isocyanate prepolymer chain by adding a diol, and forming an aqueous dispersion. Also, a polyurethane dispersion or film comprising a homogeneously distributed polyurethane bound POSS prepolymer.

### BACKGROUND

The present invention is directed to polyurethane coatings and adhesives. More particularly, the present invention is directed to the use of POSS nanoparticles to improve the properties of polyurethane compositions.

Polyhedral oligomeric silsesquioxane (POSS) based polymer nanocomposites have emerged as unique materials for various applications. Reactive POSS are functional nanoscale fillers consisting of an eight corner, —(SiO_{1.5})ₙ-based cage bearing one or more functional groups. Reactive POSS represent an interesting class of precursors for the synthesis of molecularly designed organic-inorganic hybrids. In fact, chemical reactivity and self-assembling properties of POSS structures allow the manufacture of nanostructured materials: recently, these systems were classified as zero-D nanocomposites. The growing interest in POSS hybrids stems from their characteristic architectural features which offer end products with enhanced properties compared to alternative hybrid polymer systems.

POSS have been incorporated into many organic systems such as epoxies, imides, methacrylates and rubber compounds. POSS has been incorporated into urethane to form a hybrid. Significant property enhancements have been reported for some of these POSS hybrid systems, including increased toughness, decreased flammability, high ultraviolet stability, and increased oxidation resistance. Turri and Levi, Macromolecules 38:5569 (2005) reported on the preparation of polyurethane (PU)-POSS hybrid dispersions via a prepolymer mixing process using 15 weight percent N-methylpyrrolidone (NMP) as the solvent. The presence of this solvent results in final products with unacceptable high levels of volatile organic components. Films prepared from these dispersions showed the presence of crystalline POSS domains and no change in the glass transition temperature or modulus of elasticity. Increasing dimethylol propionic acid content or increased use of cycloaliphatic isocyanates or diols results in an aqueous dispersion with an unacceptably high prepolymer viscosity. This high prepolymer viscosity prevents the POSS nanoparticles from homogeneous distribution throughout the prepolymer. Also, the POSS nanoparticles can not react with the polyurethane chain ends. Turri and Levi report gel permeation chromatography and wide angle X-ray diffraction experimental results that indicate evidence of unreacted POSS.

It is very difficult to increase the modulus of elasticity of polyurethane films because of the viscosity limitations of aqueous dispersions of polyurethane prepolymers. Providing a method to manufacture a polyurethane prepolymer with an even distribution of POSS and a homogeneous dispersion of a polyurethane/POSS hybrid polymer is desirable. Accordingly, it is desirable to provide a method of increasing the modulus of elasticity of polyurethane films by adding POSS without increasing the viscosity of the prepolymer to an unacceptable level. It would be a further advancement to provide a method that is environmentally friendly by using a less toxic solvent.

### SUMMARY OF THE INVENTION

The current invention provides a method for forming a polyurethane dispersion containing POSS nanoparticles. The ionomeric nanostructured polyurethane dispersions are manufactured by using an acetone process. The process includes forming a polyurethane dispersion containing polyhedral oligomeric silsesquioxane (POSS) nanoparticles, comprising reacting a POSS with a diisocyanate in the presence of acetone, reacting the resulting compound with a polyol and an ionic compound selected from the group consisting of an acidic diol or sodium sulfonate to form an isocyanate prepolymer chain, extending the isocyanate prepolymer chain by adding a diol, and forming an aqueous dispersion. Also, a polyurethane dispersion or film comprising a homogeneously distributed polyurethane bound POSS prepolymer. Another aspect of the invention provides a polyurethane dispersion or film comprising a homogeneous polyurethane bound POSS polymer.

### DETAILED DESCRIPTION OF THE INVENTION

Methods to form a polyurethane dispersion containing polyhedral oligomeric silsesquioxane (POSS) bound polyurethane polymer using acetone as a solvent were developed. Without limitation to the exact mechanism or commenting on the theory, the POSS nanoparticles can be unreacted with the polyurethane or covalently bound to the polyurethane polymer in the dispersion through the incorporation of isocyanate reactive groups on the POSS molecule. The prepolymer and resulting dispersions have a more homogeneous distribution of POSS nanoparticles than prepolymer and resulting dispersions formed without acetone. Materials, such as films, produced with POSS particles have improved tensile properties as evidenced by an increased modulus of elasticity and surface hardness compared to the control materials with no POSS particles present. Also, the materials, such as films, have a more homogenous distribution of POSS particles throughout the material when acetone is used as a solvent to form the polyurethane/POSS prepolymer.

To form a polyurethane/POSS prepolymer and final dispersion with improved physical properties, the prepolymer must first be formed. The prepolymer may be formed by incorporating the POSS component into polyurethane by simple melt and solution blending or by chemical incorporation by the use of functionalized POSS monomers. When using acetone as a solvent for forming the polyurethane/POSS prepolymer, the POSS has a homogenous distribution throughout the prepolymer. The prepolymer is then treated to form a water based homogeneous dispersion that can be used to make a final product, such as a film.

Homogeneous means, of a thing in respect of its constitution, consisting of parts or elements all of the same kind; of uniform nature or character throughout. POSS particles that are evenly distributed in the polyurethane prepolymer may be said to have a homogeneous distribution within the prepolymer. Furthermore, POSS particles that are evenly dispersed in the final polyurethane/POSS hybrid polymer water-based dispersion may be referred to as a homogeneous dispersion.

Viscosity means the tendency of a liquid or gas to resist by internal friction the relative motion of its molecules and hence any change of shape; the magnitude of this, as measured by the force per unit area resisting a flow in which parallel layers unit distance apart have unit speed relative to one another. The viscosity of a prepolymer is relevant because it provides an estimate of how effectively the POSS particles distribute within the prepolymer. As it is easier to mix cream into coffee than into molasses, it is easier to distribute POSS particles into a less viscous prepolymer than into a high viscosity prepolymer.

Various POSS compounds can be used including aminoethylaminopropylisobutyl polyhedral oligomeric silsesquioxane, aminoethylaminopropylcyclohexyl polyhedral oligomeric silsesquioxane, aminopropylisooctyl polyhedral oligomeric silsesquioxane, aminopropylisobutyl polyhedral oligomeric silsesquioxane, aminopropylcyclohexyl polyhedral oligomeric silsesquioxane, 1,2-propanediolisobutyl polyhedral oligomeric silsesquioxane, 1,2-propanediolcyclohexyl polyhedral oligomeric silsesquioxane, trans-cyclohexanediolisobutyl polyhedral oligomeric silsesquioxane, trans-cyclohexanediolcyclohexyl polyhedral oligomeric silsesquioxane, TMP-diolisobutyl polyhedral oligomeric silsesquioxane, TMP-diolcyclopentyl polyhedral oligomeric silsesquioxane, octahydroxypropyldimethylsilyl polyhedral oligomeric silsesquioxane, mercatopropylisobutyl polyhedral oligomeric silsesquioxane, mercatopropylisooctyl polyhedral oligomeric silsesquioxane, trisilanolisobutyl polyhedral oligomeric silsesquioxane, trisilanolcyclohexyl polyhedral oligomeric silsesquioxane and trisilanolphenyl polyhedral oligomeric silsesquioxane. In a preferred embodiment, a POSS molecule with one alkyl or aralkyl substituent that has two isocyanate reactive groups is used. Examples include diamino, diol, dithio, or combinations such as amino alcohol, amino thiol, or hydroxylthiol POSS.

Suitable aliphatic isocyanates include hexamethylene diisocyanate, butane diisocyanate, isophorone diisocyanate, 1-methyl-2,4(2,6)-diisocyanato cyclohexane, norbornane diisocyanate, tetramethylxylylene diisocyanate, hexahydroxylylene diisocyanate, and 4,4′-diisocyanatodicyclohexylmethane.

Polyols are polymers with a molecular weight from 500 to 5000 g/mol with two hydroxyl groups at the chain end. Suitable polyols include polyesters, polyethers, polycarbonates and polyesteramides such as dihydroxypolyesters of dicarboxylic acids or their anhydrides, e.g. adipic acid, succinic acid, phthalic anhydride, isophthalic acid, terephthalic acid, suberic acid, azeleic acid, sebacic acid, tetrahydrophthalic acid, maleic anhydride, dimeric fatty acids and diols, e.g. ethylene glycol, propylene glycol, 1,4-propanediol, diethylene glycol, triethylene glycol, 1,4-butanediol, 1,6-hexanediol, trimethylenepentanediol, 1,4-cyclohexanediol, 1,4-cyclohexanedimethanol, neopentyl glycol, 1,8-octanediol; polyesters and polycarbonates based on lactones, in particular based on epsilon.-caprolactone, polycarbonates as obtainable by reacting, for example, the abovementioned diols with diaryl or dialkyl carbonates or phosgene. Polyethers, obtained, for example, by using diols or water as an initiator molecule by polymerization with ethylene oxide and/or propylene oxide and by polymerization of tetrahydrofuran. Preferred polyols include ethylene glycol, 1,4-butanediol, 1,6-hexanediol, neopentyl glycol, trimethylpentanediol, propylene glycol, 1,3-propanediol, 1,4-cyclohexanedimethanol, and mixtures thereof.

Chain extending diols are small molecules having 2-10 carbon atoms with two hydroxyl groups at the chain ends. Chain extending diols include butane diol or hexane diol or ethylene glycol.

Ionic diols are small molecules having 3-10 carbon atoms comprising two hydroxyl groups at the chain ends and one carboxylate/sulfonate ionic group. Ionic diols such as diols carrying carboxyl or carboxylate groups may be used as the diol carrying ionic or potentially ionic groups. Examples include 2,2-bis(hydroxymethyl)alkanecarboxylic acids, such as dimethylolacetic acid, 2,2-dimethylolpropionic acid, 2,2-dimethylolbutyric acid, 2,2-dimethylolpentanoic acid, dihydroxysuccinic acid. Dimethylolpropionic acid is preferably used. Additionally, sodium sulfonate, dimethylol propionic acid, demethylol butanoic acid, or sulfonate diol may be used.

Optional potential ionic groups, in particular carboxyl groups of the NCO prepolymer, are neutralized with a base not reactive towards NCO groups before the neutralized prepolymer is reacted with water. Suitable bases not reactive towards NCO groups are preferably tertiary amines, in particular the tertiary amines such as trimethylamine, triethylamine, N-methylmorpholine, N-methylpiperidine or N,N-dimethyl-N-[2-ethoxy]-ethylamine.

The following chemical formulas illustrate one example of a mechanism for forming a polyurethane dispersion containing polyhedral oligomeric silsesquioxane (POSS) bound polyurethane polymer.

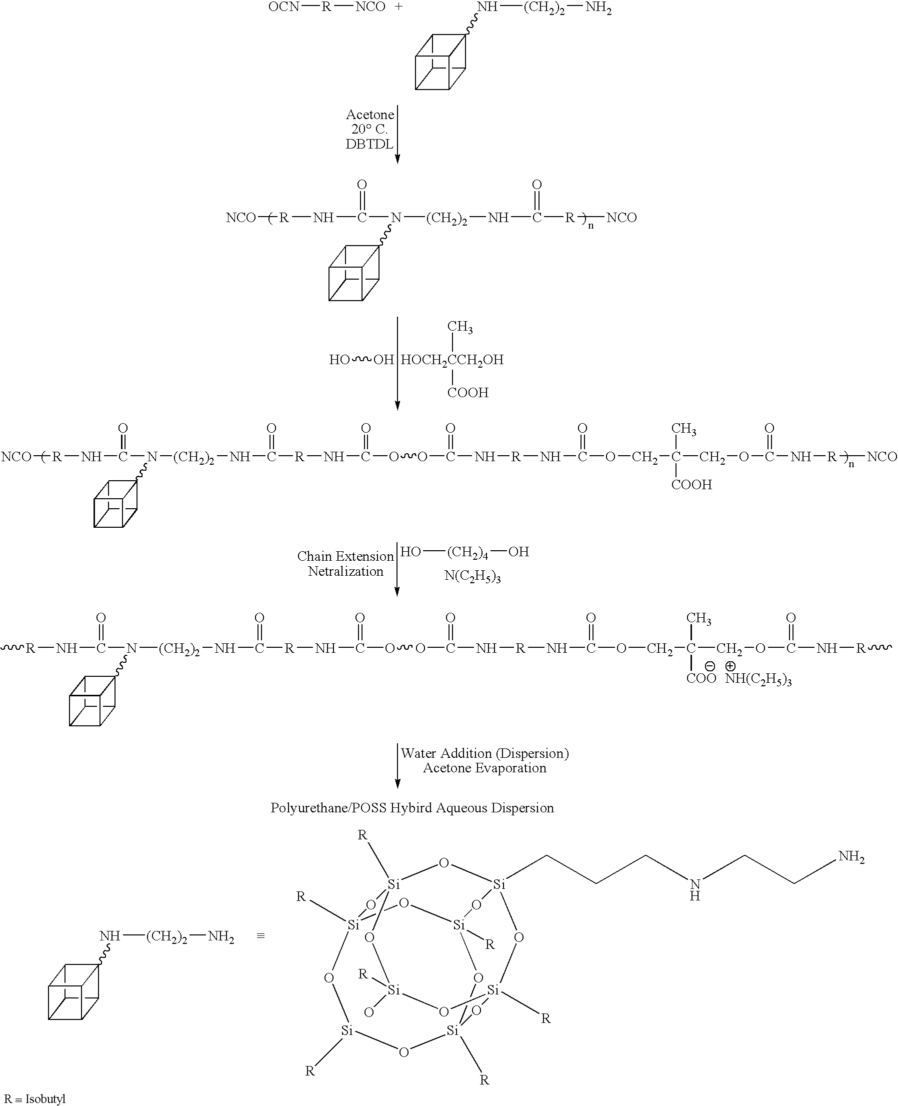

### EXAMPLES

In the following examples, poly(hexylene adipate-isophthalate)diol (Desmophen 1019-55), and isophorone diisocyanate (IPDI) were obtained from Bayer MaterialScience, Pittsburgh, Pa. Dimethylol propionic acid (DMPA), dibutytin dilaurate (DBTDL), triethyl amine (TEA), and 1,4-butane diol (BD) were obtained from Aldrich Chemical Co. Acetone and methylene chloride were obtained from Fluka Chemical Co. Aminoethylaminopropylisobutyl polyhedral oligomeric silsesquioxane (reactive amino-POSS), 1,2-propanediolisobutyl polyhedral oligomeric silsesquioxane (reactive diol-POSS), trisilanolisobutyl-POSS (unreactive POSS) were obtained from Hybrid Plastics, MS.

### Example 1

Synthesis of Polyurethane (PU) Dispersion. In a 250 ml round bottom flask, 125 g of acetone was taken. Amino-POSS (10 g) was added, and the contents were stirred for 2-3 minutes. The solution was filtered to a 500 ml four neck round bottom flask. The amount of amino-POSS dissolved in the acetone was calculated. IPDI (23 g) was added drop wise with constant stirring at 20° C. After 20 minutes DBTDL was added as a catalyst and stirring was continued for an additional 10 minutes. The flask was then attached to a mechanical stirrer, thermometer, condenser with nitrogen inlet and outlet, and a pipette outlet. Desmoplen 1019-55 (61.1 g) and DMPA (3.1 g) were added and stirring was continued until a homogenous mixture was obtained. The polymerization was continued for about 8 hours to afford an isocyanate terminated prepolymer. The change of the NCO content during the reaction was monitored using a standard dibutylamine back titration method. Upon reaching the theoretical NCO value, the prepolymer was chain extended by adding butane diol at 58° C. over 2 hours to form the PU-POSS nanocomposite.

The PU-POSS nanocomposite was neutralized by triethyl amine (DMPA equiv.) by stirring for 30 minutes while maintaining the temperature at 55° C. An inverse dispersion was formed by adding water slowly to the neutralized PU-POSS nanocomposite mixture at 45-50° C. over 30 minutes with agitation speed of 600 rpm. The stirring was continued at the same temperature for an additional 30 minutes. Acetone from the PU-POSS nanocomposite dispersion was removed or distilled at 35° C. on a rotary evaporator. In the final polymerization step the ratio of isocyanate groups to chain extender hydroxyl groups (from BD) was 1.1/1.

The results of testing of the final product indicate that acetone is a good solvent for functionalized POSS monomers, and carrying out the first step of the polymer synthesis in acetone was found to be essential in obtaining a homogeneous product. The reaction mixtures were analyzed at each step of the sequence to verify that the co-monomer was incorporated. GPC traces of the diamino-POSS monomer and the three steps of polymerization prior to neutralization are useful to qualitatively follow the increase in molecular weight at different stages of the polymerization. The GPC traces clearly show that the vast majority of the diamino-POSS is incorporated on the first step and that the final polymer is free of residual POSS comonomer (Mₙ˜700 g/mol). GPC testing of the final product show increase in molecular weight of the polymer and complete disappearance of unreacted POSS macromer of molecular weight of approximately 700 g/mol. That is, the dispersion is essentially free of POSS macromer. Wide angle X-ray diffraction (WAXD) test results show there is no crystalline domain of unreacted free POSS. These combined test results show that POSS is homogeneously distributed in the polyurethane matrix. When compared to dispersion manufacturing methods that do not use acetone, GPC shows a signal corresponding to free POSS at approximately 700 g/mol and WAXD shows a crystalline peak of free POSS.

### Examples 2-6

A series of PU dispersions were made using various amounts of amino POSS (Table 1). The DMPA content was held at 3 weight percent, solid content at 32 weight percent and chain extension at 90 percent. The triethyl amine content was adjusted to keep a 1:1 ratio of COOH to N(C₂H₅)₃. The Mₙ value of the polymer made from diamino POSS with IPDI is 1200 g/mol. The molecular weight of the prepolymer, formed by reacting further with polyester polyol and DMPA, is 2800 g/mol. The ratio of isocyanate/diol was kept 1.6/1 for the synthesis of prepolymer. The prepolymer was chain extended by butane diol (prepolymer/butane diol ˜1.1/1) yielding a final polymer with molecular weight ˜25, 000 g/mol. GPC analyses of the final polymer showed the absence of free POSS macromer (Mₙ˜700 g/mol by PMMA calibration). Therefore, the homogeneous solution of amino functionalized POSS reacted efficiently with the diisocyanate and incorporated completely with the ionomeric polyurethane backbone. All the polyurethane samples were soluble in THF (GPC eluent) due to the presence of a lower percentage of urea segments, and absence of gel in the polymerization.

TABLE 1
Polymer Compositions. The chart below uses the following
abbreviations - isophorone diisocyanate (IPDI), dimethylol propionic
acid (DMPA), and 1,4-butane diol (BD).

| | POSS | IPDI | Polyester Diol | DMPA | |
|---|---|---|---|---|---|
| Sample | wt (equiv) | wt (equiv) | wt (equiv) | wt (equiv) | BD wt (equiv) |
| PU0 | 0 (0) | 21.2 (0.190) | 73.3 (0.071) | 3.1 (0.046) | 2.4 (0.053) |
| PU4 | 4.0 (0.009) | 21.7 (0.196) | 68.5 (0.067) | 3.1 (0.046) | 2.4 (0.053) |
| PU6 | 6.0 (0.013) | 22.2 (0.199) | 66.1 (0.064) | 3.1 (0.046) | 2.5 (0.055) |
| PU10 | 10.0 (0.021) | 23.0 (0.207) | 61.1 (0.060) | 3.1 (0.046) | 2.6 (0.057) |
| PU10A | 10.0 (0.021) | 22.9 (0.206) | 61.2 (0.060) | 3.1 (0.046) | 2.6 (0.057) |

PU4–PU10: Diamino-POSS
PU10A: Diol-POSS

TABLE 2
Particle size and viscosity of the PU-POSS hybrid dispersions

| Sample | Particle Size (nm) | η (mPa-s) |
|---|---|---|
| PU0 | 107 | 77 |
| PU4 | 109 | 75 |
| PU6 | 111 | 74 |
| PU10 | 112 | 73 |
| PU10A | 113 | 75 |

This chart shows that the particle size was within the limits of reproducibility with increasing concentration of POSS. This chart also illustrates almost consistent (little variation) in the viscosity with increasing concentration of POSS. Particle sizes (PS) were determined using a Microtrac UPA 250 light scattering ultrafine particle analyzer. The sample was diluted to the required concentration with distilled water before measurement. The inclusion of the POSS monomers did not have an impact on the solution properties of the dispersions relative to the control (PU0). The minor differences in particle size and viscosity with increasing POSS content are within the limits of reproducibility and indicate that the POSS monomers do not affect the dispersion step (Table 2). For all of the observed PU-POSS hybrid dispersions, the particle sizes were unimodal and remained constant over six months of storage at room temperature.

### Examples 7-10

Films were prepared using the dispersions described above by casting the dispersion onto a polypropylene plate and drying in a vacuum oven at 120° C. for three days. The films were used for dynamic mechanical analysis (DMA), wide angle X-ray diffraction (WAXD) and mechanical testing. The weight percentage of the solid was verified by heating 1 g of dispersion in a glass plate in a vacuum oven at 125° C. for 6 hours. Viscosity measurements of the dispersions were performed using Brookfield DV-I viscometer, at a shear rate of 100 s⁻¹ at 25° C. GPC measurements were carried out using a Polymer Laboratories, model PL-ELS 1000 equipped with an ELSD detector, PL gel 5 μm mixed C, 300×7.5 m column and Waters 590 HPLC pump using CH₂Cl₂ as a solvent at a flow rate of 1 ml/min. The GPC was calibrated with PMMA standards. Differential scanning calorimetry (DSC) was performed using a TA Instruments DSC 2920 module (TA 2100 controller) at a heating rate of 10° C./min in a nitrogen atmosphere. Thermogravimetric analysis (TGA) was conducted on a TA instruments SDT 2960 module (TA 2100 controller) at a heating rate of 20° C./min under nitrogen. The viscoelastic measurements of PU films were carried out using an advanced Rheometrics Expansion System (ARES), equipped with two 25 mm diameter parallel plates.

TABLE 3
Physical Properties of PU-POSS Nanocomposite Film

| | POSS | Contact | Surface | T_{g} (° C.) | Melt η | Tensile | Elonga- |
|---|---|---|---|---|---|---|---|
| Sam- | (wt | Angle | Energy | (Hard | (Pa) at | Strength | tion |
| ple | %) | (°) | (mN/m) | Segment) | 110° C. | (N/cm²) | (%) |
| PU0 | 0 | 66.1 | 36.0 | 53 | 392 | 60 | 2000 |
| PU4 | 4 | 82.0 | 23.6 | 56 | 689 | 102 | 1200 |
| PU6 | 6 | 85.0 | 21.5 | 66 | 861 | 210 | 1100 |
| PU10 | 10 | 89.0 | 18.8 | 93 | 1438 | 625 | 900 |

Films prepared from the dispersions were clear and defect free. Table 3 shows the dynamic viscosity at a frequency 100 s⁻¹ with POSS weight percent. The viscosity increases linearly with increasing POSS composition i.e., the incorporation of small amount of POSS to the molecular chain of PU produced a significant change in the dynamic viscosity of PU. This increase in viscosity could be attributed to the reinforcement of POSS in the PU backbone. The physical properties changed systematically with the incorporation of POSS monomers and are indicative of homogeneous incorporation. DMA measurements show that the glass transition temperature of the PU hard segment increased from 53 to 90° C. as the diamino-POSS content increased from 0 to 10 weight percent. Within the same samples the soft segment glass transition temperature remained essentially constant at −18° C. Concurrently there was an increase in the modulus at break for the POSS containing films, reflecting the increased hard block content. This shows a preferential incorporation of the POSS residues into the polyurethane hard blocks with no separate formation of POSS rich phase.

The stress-strain results of polyurethane films are also presented in Table 3. The tensile strength increases with increasing POSS content, due to the incorporation of POSS into the PU matrix. The elongation to break (%) decreases with the increase in strength of the PU films.

The surface behavior of the samples was also investigated through measurements of contact angles against water (Table 3). The POSS macromer concentration strongly enhances the contact angles of the coated surface against water. The total surface energy of polyurethane was about 20 mN/m lower at 10 weight percent of POSS. In particular, the polar components seem sensitive to the presence of even few percentages of POSS. This means the POSS nanostructures screen the polar groups like urethanes and carboxyls and are preferentially oriented air-side.

### ADVANTAGES

These experimental results show that waterborne polyurethane hybrid dispersions have been successfully synthesized through the incorporation of amino and hydroxyl functionalized POSS monomers in the polyurethane ionomeric backbone using the acetone process. All the dispersions are stable for more than a year. That the dispersions contain low volatile organic components that are less than one percent shows the environmental advantages of the acetone process over the prepolymer method. The POSS macromers appear to be included in the PU hard segments as shown by the absence of crystalline domains and the steady increase in hard segment glass transition temperature with increased POSS content. Storage modulus, tensile strength, complex viscosity, and glass transition temperature of the hard segments of PU film increased with increased POSS content. The films remained transparent with up to 10 weight percent incorporation of the POSS monomers. Interestingly, films prepared from the POSS containing dispersions showed louver surface wettability. This effect may be due to either a stratification of the non-polar components of the coating close to polymer-air interface or a topographical change of the surface due to formation of nanostructures.

This acetone-based process is desirable over the processes that do not use acetone because the final product has improved physical properties including glass transition temperature, modulus of elasticity, tensile strength, and viscosity. Furthermore the volatile organic components of the final product of the acetone based process are much lower than the greater than 15 percent volatile organic components experienced with products formed by a process that does not use acetone.

While the invention has been described with respect to the presently preferred embodiments, it will be appreciated that changes can be made without departing from the scope of the invention.

What is claimed is:

1. A process for forming a polyurethane dispersion containing polyhedral oligomeric silsesquioxane (POSS) nanoparticles, comprising:
reacting a POSS with a diisocyanate in the presence of acetone;
reacting the resulting compound with a polyol and an ionic compound selected from the group consisting of an acidic diol or sodium sulfonate to form an isocyanate prepolymer chain;
extending the isocyanate prepolymer chain by adding a diol; and
forming an aqueous dispersion.

2. The process of claim 1, wherein the chain extending diol comprises butane diol, hexane diol, or ethylene glycol.

3. The process of claim 1, wherein the acidic diol comprises dimethylol propionic acid, demethylol butanoic acid, or sulfonate diol.

4. The process of claim 1, wherein the polyol is a polyester polyol, polyether polyol, or polycarbonate polyol.

5. The process of claim 1, wherein the process further comprises removing the acetone by distillation after reacting a POSS with a diisocyanate.

6. The process of claim 1, wherein the POSS comprises aminoethylaminopropyl-isobutyl polyhedral oligomeric silsesquioxane or polyhedral oligomeric silsesquioxane diol.

7. The process of claim 1, wherein the diisocyanate comprises isophorone diisocyanate, hexamethylene diisocyanate or dicyclohexyl methane diisocyanate.

8. The process of claim 1, further comprising adding a catalyst after reacting a POSS with a diisocyanate in the presence of acetone.

9. The process of claim 8, wherein the catalyst comprises dibutytin dilaurate.

10. A polyurethane dispersion comprising a homogeneously distributed polyurethane bound POSS prepolymer.

11. The polyurethane dispersion of claim 10, wherein the polyurethane bound POSS prepolymer is dispersed in acetone.

12. The polyurethane dispersion of claim 10, wherein the polyurethane bound POSS polymer is dispersed in water.

13. The polyurethane dispersion of claim 10, wherein the polyurethane bound POSS polymer is dispersed in acetone and water.

14. The polyurethane dispersion of claim 12, wherein the dispersion is essentially free of organic solvent.

15. The polyurethane dispersion of claim 12, wherein the dispersion is essentially free of POSS macromer.

16. The polyurethane dispersion of claim 10, wherein the dispersion has a viscosity of 73 to 77 mPa·s.

17. The polyurethane dispersion of claim 10, wherein the dispersion has a unimodal distribution of POSS in the polyurethane bound POSS polymer.

18. A polyurethane film comprising a homogeneous polyurethane bound POSS polymer.

19. The polyurethane film of claim 18, wherein the film is essentially free of POSS macromer.

20. The polyurethane film of claim 18, wherein the film has a tensile strength of about 100 N/cm² to about 625 N/cm².

21. The polyurethane film of claim 18, wherein the film has a contact angle of about 82° to about 89°.

22. The polyurethane film of claim 18, wherein the film has a surface energy of about 18 mN/m to about 24 mN/m.
